(19) United States
(12) Patent Application Publication
(10) Pub. No.: US 2010/0285379 A1
(43) Pub. Date: Nov. 11, 2010

(54) Transitioning an electrochemical cell stack between a power producing mode and a pumping mode

(76) Inventors: Jeffrey W. Schrieber, Troy, NY (US); Richard Maddaloni, Mechanicville, NY (US); Zhigang Qi, Albany, NY (US); Chris Brown, Cohoes, NY (US); Christopher J. Chuah, P.E., Clifton Park, NY (US); Glen Benson, Saratoga, NY (US); James Winkelman, Bloomfiled, MI (US)

Correspondence Address: TROP, PRUNER & HU, P.C., 1616 S. VOSS ROAD, SUITE 750, HOUSTON, TX, 77057-2631, US

(21) Appl. No.: 11/985,044

(22) Filed: Nov. 13, 2007

(51) Int. Cl. H01M 8/04

(52) U.S. Cl. 429/432

(57) ABSTRACT

A technique includes operating an electrochemical cell stack in a power producing mode, including communicating a fuel flow in an anode chamber of the stack and communicating an oxidant flow in a cathode chamber of the stack. The technique includes halting the oxidant flow and monitoring a voltage of the stack while the oxidant flow is halted, and in response to the voltage decreasing below a predefined threshold, transitioning the stack into an electrochemical cell pumping mode.

### BACKGROUND

The invention generally relates to transitioning an electrochemical cell stack between a power producing mode and a pumping mode.

A fuel cell is an electrochemical device that converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the 50° Celsius (C) to 75° C. temperature range. Another type employs a phosphoric-acid-based polybenzimidazole, PBI, membrane that operates in the 150° to 200° temperature range. At the anode, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

Anode:H₂→2H⁺+2e⁻ Equation 1

Cathode:O₂+4H++4e⁻→2H₂O Equation 2

The PEM fuel cell is only one type of fuel cell. Other types of fuel cells include direct methanol, alkaline, phosphoric acid, molten carbonate and solid oxide fuel cells.

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one cell of the stack. The plates may include various surface flow channels and orifices to, as examples, route the reactants and products through the fuel cell stack. Electrically conductive gas diffusion layers (GDLs) may be located on each side of a catalyzed PEM to form the anode and cathodes of each fuel cell. In this manner, reactant gases from both the anode and cathode flow-fields may diffuse through the GDLs to reach the catalyst layers.

In general, a fuel cell is an electrochemical cell that operates in a forward mode to produce power. However, the electrochemical cell may be operated in a reverse mode in which the cell produces hydrogen and oxygen from electricity and water. More specifically, an electrolyzer splits water into hydrogen and oxygen with the following reactions occurring at the anode and cathode, respectively:

Anode:2H₂O→O₂+4H⁺+4e⁻ Equation 3

Cathode:4H⁺+4e⁻→→2H₂ Equation 4

An electrochemical cell may also be operated as an electrochemical pump. For example, the electrochemical cell may be operated as a hydrogen pump, a device that produces a relatively pure hydrogen flow at a cathode exhaust of the cell relative to an incoming reformate flow that is received at an anode inlet of the cell. In general, when operated as an electrochemical pump, the cell has the same overall topology of the fuel cell. In this regard, similar to a fuel cell an electrochemical cell that operates as a hydrogen pump may contain a PEM, gas diffusion layers (GDLs) and flow plates that establish plenum passageways and flow fields for communicating reactants to the cell. However, unlike the arrangement for the fuel cell, the electrochemical pump cell receives an applied voltage, and in response to the received current, hydrogen migrates from the anode chamber of the cell to the cathode chamber of the cell to produce hydrogen gas in the cathode chamber. A hydrogen pump may contain several such cells that are arranged in a stack.

### SUMMARY

In an embodiment of the invention, a technique includes operating an electrochemical cell stack in a power producing mode, including communicating a fuel flow in an anode chamber of the stack and communicating an oxidant flow in a cathode chamber of the stack. The technique includes halting the oxidant flow and monitoring a voltage of the stack while the oxidant flow is halted; and in response to the voltage decreasing below a predefined threshold, transitioning the stack into a pumping mode.

In another embodiment of the invention, a system includes an oxidant source, a fuel source, an electrochemical cell stack and a control subsystem. The oxidant source provides an oxidant flow, and the fuel source provides a fuel flow. The electrochemical cell stack includes an anode chamber and a cathode chamber. The control subsystem is adapted to communicate the fuel flow in the anode chamber and communicate the oxidant flow in the cathode chamber in a power producing mode of the stack. The control subsystem is also adapted to halt the oxidant flow and monitor a voltage of the stack while the oxidant flow is halted; and the control subsystem is adapted to, in response to the voltage decreasing below a predefined threshold, transition the stack into a pumping mode.

Advantages and other features of the invention will become apparent from the following drawing, description and claims.

### BRIEF DESCRIPTION OF THE DRAWING

FIG. 1 is a schematic diagram of an electrochemical cell system according to an embodiment of the invention.

FIGS. 2 and 3 depict techniques to transition an electrochemical cell system between a power producing mode and a pumping mode according to different embodiments of the invention.

### DETAILED DESCRIPTION

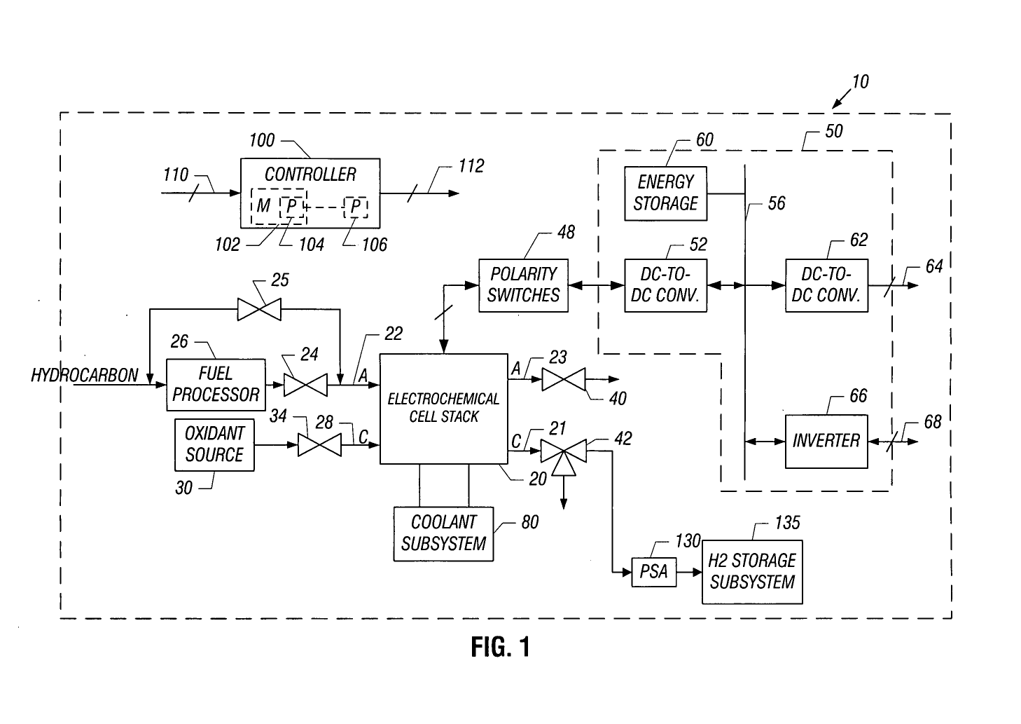

Referring to FIG. 1, an electrochemical cell system 10 (a residential energy station, for example) in accordance with embodiments of the invention includes a dual mode electrochemical cell stack 20 (a stack containing PEM cells, for example) that functions in one of two modes: a power producing mode in which the stack 20 functions as a fuel cell stack to produce electrical power; and a pumping mode in which the stack 20 functions as an electrochemical pump to purify an incoming flow (a reformate flow, for example) to produce a relatively purified fuel flow (a relatively pure hydrogen fuel flow, for example), which may be stored in a hydrogen storage subsystem 135, for example. As described herein, the electrochemical cell system 10 uses a technique to transition the stack 20 between the power producing and pumping modes in a significantly short time interval.

In the power producing mode, the electrochemical cell stack 20 receives an incoming fuel flow at its anode inlet 22. As an example, the incoming fuel flow may be a reformate flow (about fifty percent hydrogen, for example), which is furnished by a fuel processor 26. As a more specific example, the fuel processor 26 may receive an incoming hydrocarbon flow (a liquefied petroleum gas or natural gas flow, as examples), and the fuel source 26 reforms the hydrocarbon flow to produce an incoming fuel flow (i.e., reformate) to the stack 20, which is received at the anode inlet 22. In general, the fuel flow is communicated from the anode inlet 22 through the serpentine flow channels of the anode chamber of the stack 20 to promote electrochemical reactions pursuant to Eqs. 1 and 2; and the fuel flow produces a corresponding anode exhaust flow at an anode outlet 23 of the stack 20.

As examples, the anode exhaust may be partially routed back to the anode inlet 22, may be vented to ambient, may be routed to a flare or oxidizer, etc., depending on the particular embodiment of the invention. As another example, the anode chamber may be closed off, or “dead ended” (also called “dead headed”) except for possibly a bleed or purge flow during the power producing mode. Thus, many variations are contemplated and are within the scope of the appended claims.

The stack 20 also receives an incoming oxidant flow at a cathode inlet 28. In this regard, an oxidant source 30 (an air compressor or blower, as examples) may furnish an air flow that serves as the incoming oxidant flow to the stack 20. The incoming oxidant flow is routed through the serpentine flow channels of the cathode chamber of the stack 20 for purposes of promoting the electrochemical reactions (see Eqs. 1 and 2) inside the stack 20 to produce electrical power. The oxidant flow through the cathode chamber produces a cathode exhaust flow, which appears at a cathode outlet 21 of the stack 20. The cathode exhaust flow may be routed during the power producing mode through the valve 42 and to a flare or oxidizer, to the surrounding environment, to the cathode inlet 28 or anode inlet 22, etc.

As depicted in FIG. 1, the electrochemical cell system 10 may include valves 24 and 34, which are operated by a system controller 100 for purposes of controlling the incoming fuel and oxidant flows, respectively, to the fuel cell stack 20. Additionally, the electrochemical cell system 10 may include a valve 40 and the valve 42, which are operated by the controller 100 for purposes of controlling external communication with the anode outlet 23 and cathode outlet 21, respectively, of the stack 20. As further described below, during the transition between the power producing and pumping modes, the controller 100 operates the valves 34 and 42 to isolate the cathode chamber of the stack 20 from any additional oxidant flow. In this context, isolation of the cathode chamber means that the valves 42 and 34 have states in which the cathode inlet 28 and outlet 21 are closed, thereby sealing off the stack's cathode chamber.

During the pumping mode, the controller 100 closes off the valve 34 and opens the valves 24 and 40 for purposes of allowing reformate from the fuel source 26 to flow through the anode chamber of the stack 20. In this mode of operation, the stack 20 receives electrical power (as further described below) and promotes electrochemical reactions to cause the migration of hydrogen ions across the cell membranes of the stack 20 to produce purified hydrogen, which appears as an exhaust flow at the cathode outlet 21.

The electrochemical cell system 10 includes a power conditioning subsystem 50 that, during the power producing mode of the stack 20, receives electrical power from the stack 20 and conditions the power into the appropriate form for the loads of the system 10. In this regard, the loads may include auxiliary loads of the electrochemical cell system 10, as well as external loads (residential or commercial AC or DC loads, as examples) and possibly an AC power grid.

During the pumping mode, the power conditioning subsystem 50 provides electrical power to the stack 20. The origin of this electrical power may be the AC power grid, energy that is stored in energy storage 60 (a battery bank, for example) or another source of power.

In accordance with some embodiments of the invention, the power conditioning subsystem 50 includes a DC-to-DC converter 52, which, during the power producing of the stack 20, converts the DC stack voltage into a voltage level for a power bus 56. The energy storage 60 is coupled to the bus 56, and during the power producing mode of the stack 20, power is transferred via the bus 56 to store energy in the energy storage 60. During the pumping mode, the converter 52 communicates power from the bus 56 to the stack 20 by converting the voltage level of the bus 56 into the appropriate DC stack level for promoting the pumping and achieving the desired stack current.

As also depicted in FIG. 1, the power conditioning subsystem 50 may include additional components for purposes of conditioning the power from the bus 56 into the appropriate form for the loads of the system 10. More specifically, the power conditioning condition subsystem 50 may include another DC-to-DC converter 62, which converts the voltage of the bus 56 into the appropriate voltage or voltages (which appear on output lines 64) for auxiliary and external loads of the system 10.

In some embodiments of the invention, the power conditioning subsystem 50 may include an inverter 66, which converts the DC voltage from the power bus 56 into one or more AC voltages (that appear on terminals 68) for external AC loads, auxiliary AC loads and/or possibly the AC power grid. For the pumping mode, the inverter 66 may deliver power from the AC grid by communicating an AC signal received at the terminal 68 into the appropriate voltage level for the bus 56.

Among the other features of the electrochemical cell system 10, the system 10 may include a hydrogen storage subsystem 135 that stores hydrogen that is produced by the stack 20 during the pumping mode. More specifically, during the pumping mode, the cathode exhaust may be routed through the valve 42 to a pressure swing absorber (PSA) 130, which removes impurities from the cathode exhaust to further purify the hydrogen stream. The hydrogen storage subsystem 135 is connected to the outlet of the PSA 130, and thus, during the pumping mode, hydrogen may be stored in the subsystem 135 that is generated due to the pumping of the stack 20.

The system 10 may also include polarity switches 48, which are coupled between the stack 20 and the power conditioning subsystem 50 for purposes of ensuring that the appropriate polarity exists between the terminals of the stack 20 and the power conditioning subsystem 50. In this regard, the polarity switches 48 operate to reverse the polarity of the stack terminals between the power producing and electrochemical cell pumping modes of the stack 20.

Among its other features, in accordance with some embodiments of the invention, the electrochemical cell system 10 may also include a coolant subsystem 80, which communicates a coolant through the stack's coolant channels for purposes of regulating the stack temperature.

As also shown in FIG. 1, the system controller 100 may include a processor 106 (representative of one or more microprocessors and/or microcontrollers), which executes instructions 104 that are stored in a memory 102 for purposes of controlling the various aspects of the system 10. In this regard, the controller 100 may include various output terminals 112 for purposes of regulating operation of the fuel processor 26; opening and closing valves (such as the valves 24, 28, 40 and 42, as examples); operating various motors (such as a motor of the oxidant source 30; for example), controlling the power mode to pumping mode transition, as described in more detail below; regulating operation of the converters 52 and 62; regulating operation of the inverter 66; etc., as just a few examples. The controller 100 also includes various input terminals 110 for purposes of monitoring sensed conditions, voltages and/or currents of the system 10, as well as receiving commands and other information for purposes of controlling operations of the system 10.

The controller 100 may be viewed as schematically representing one or more separate controllers of the system 10. For example, in accordance with some embodiments of the invention, the system 10 includes a system controller and a controller for the DC-to-DC converter 62, which communicate with each other via a serial communication link. Thus, many variations are contemplated and are within the scope of the appended claims.

It is noted that the electrochemical system 10 depicted in FIG. 1 is merely for purposes of an example, as the depicted features of the system have been simplified for purposes of clarifying the certain aspects of the invention, which are described herein. Other variations of the system 10 are contemplated and are within the scope of the appended claims.

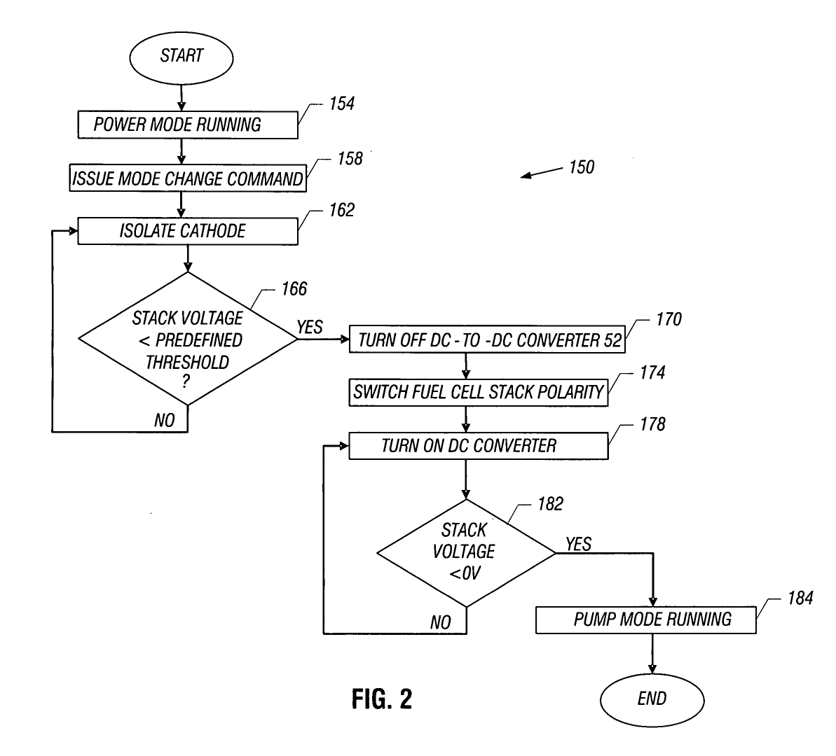

Referring to FIG. 2 in conjunction with FIG. 1, in accordance with some embodiments of the invention, a technique 150 may be used to transition the stack 20 from the power producing mode into the pumping mode. Pursuant to the technique 150, prior to the transition, the stack 20 is operating in the power producing mode, pursuant to block 154. The transition begins at the issuance of a mode change command, pursuant to block 158. More specifically, in accordance with some embodiments of the invention, a separate process of the controller 100 (see FIG. 1) may determine when a mode change is to occur, a controller other than the controller may determine when the mode change is to occur, the mode change may occur in response to a system user input, the mode change may occur in response to the amount of stored hydrogen in the subsystem 110 decreasing below a predetermined level, etc.

In response to the mode change command, the controller 100 performs the portion of the technique 150 from blocks 162 to 184. More specifically, the controller 100 initially closes the valves 34 and 42 to isolate the cathode chamber of the stack 20, as depicted in block 162. While the cathode chamber remains isolated, a fuel flow (reformate, for example) continues to be communicated through the anode chamber of the stack 20 and during this time period, the load placed on the stack 20 via the load conditioning subsystem 50 remains. The remaining oxidant inside the cathode chamber, along with the fuel flow through the anode chamber, continues to promote electrochemical reactions to generate electrical power that is routed to the load. However, due to the finite supply of oxidant in the cathode chamber, the stack voltage gradually decreases. In addition, some of the hydrogen in the anode chamber diffuses to the cathode chamber and consumes the remaining oxygen in the cathode chamber, leaving an inert nitrogen blanket in the cathode chamber. The controller 100 monitors the decaying stack voltage (through a stack voltage sensor, for example) until the controller 100 determines (diamond 166) that the stack voltage has decreased below a predefined threshold (2 or 5 volts, as non-limiting examples).

Upon determining (diamond 166) that the stack voltage is below the predefined threshold, the controller 100 turns off the DC-to-DC converter 52, pursuant to block 170 (i.e., removes the load from the stack 20) and subsequently operates the polarity switches 48 to switch the stack polarity, pursuant to block 174. Alternatively, in accordance with some embodiments of the invention, relay-operated switches, or contactors, connect the stack 20 to the power conditioning subsystem 50; and the controller 100 opens the contactors when the stack voltage is below the predefined threshold to disconnect the load from the stack 20.

At this point, the controller 100 reopens the valve 42 to permit a flow from the cathode outlet 21 and turns on (block 178) the DC-to-DC converter 52. Thus, the power conditioning subsystem 50 communicates power to the stack 20 for purposes of promoting the electrochemical pumping inside the stack 20, and as a result, a stack voltage reappears. The controller 100 monitors the increasing stack voltage (through a stack voltage sensor, for example) and in response to a determination (diamond 182) that the stack voltage is greater than a predefined threshold (such as zero volts, for example), the controller 100 sets a flag to indicate that the pump mode is running, pursuant to block 184.

Because a load is connected to the stack 20 while the cathode chamber of the stack 20 is isolated, the overall time to transition the stack 20 from the power producing mode to the pumping mode is relatively short. As a more specific example, in accordance with some embodiments of the invention, the overall time to transition the stack 20 from the power producing mode to the pumping mode is about 150 seconds. It is noted that at the conclusion of the transition, hydrogen and inert gases are present in the cathode chamber of the stack 20. By connecting the load to the stack terminals, the oxidant contained in the stack is consumed relatively quickly due to the power producing electrochemical reactions (see Eqs. 1 and 2) consuming the remaining oxidant in the cathode chamber.

It is noted that the technique 150 prevents carbon corrosion of the flow plates and the electrodes due to the prevention of fuel starvation during the transition between the power producing and pumping modes. Therefore, the stack 20 maintains its stack voltage with a minimal stack voltage loss due to the cycling of the stack 20 between the power producing and pumping modes.

As an example, a test was conducted using an electrochemical stack that contained PEM cells. The stack was subject to about 20,000 cycles of power and pumping modes, where in each cycle the stack operated in the power producing mode for two minutes and then operated in the pumping mode for one minute. The stack was subjected to a current density of 0.6 amps per centimeter squared during both modes, with the pumping voltage of each cell being approximately equal to −0.06 volts. The test was characterized by the following parameters: a cell temperature of 60° Celsius (C); a humidification temperature of 60° C.; a heating tape temperature of 65° C.; an ambient pressure; reactants of hydrogen and air; and a stoichiometric ratio of 1.5/2.5 hydrogen to air. For this test, the technique 150 was used to transition the stack between the power producing and pumping modes, and this transition took less than 3 seconds. At the end of the test, the cell voltage had decreased by only approximately 22 millivolts.

Other variations are contemplated and are within the scope of the appended claims. For example, in accordance with other embodiments of the invention, natural diffusion may be used to communicate hydrogen into the cathode chamber for purposes of transitioning the stack 20 from a power producing to pumping mode. For these embodiments of the invention, the load to the stack 20 is isolated from the stack 20 at the beginning of the transition so that natural diffusion of the hydrogen to the cathode chamber controls the stack's transition time. As an example, in accordance with some embodiments of the invention, the transition consumes approximately fifteen minutes, although other transition times are contemplated, in accordance with other embodiments of the invention.

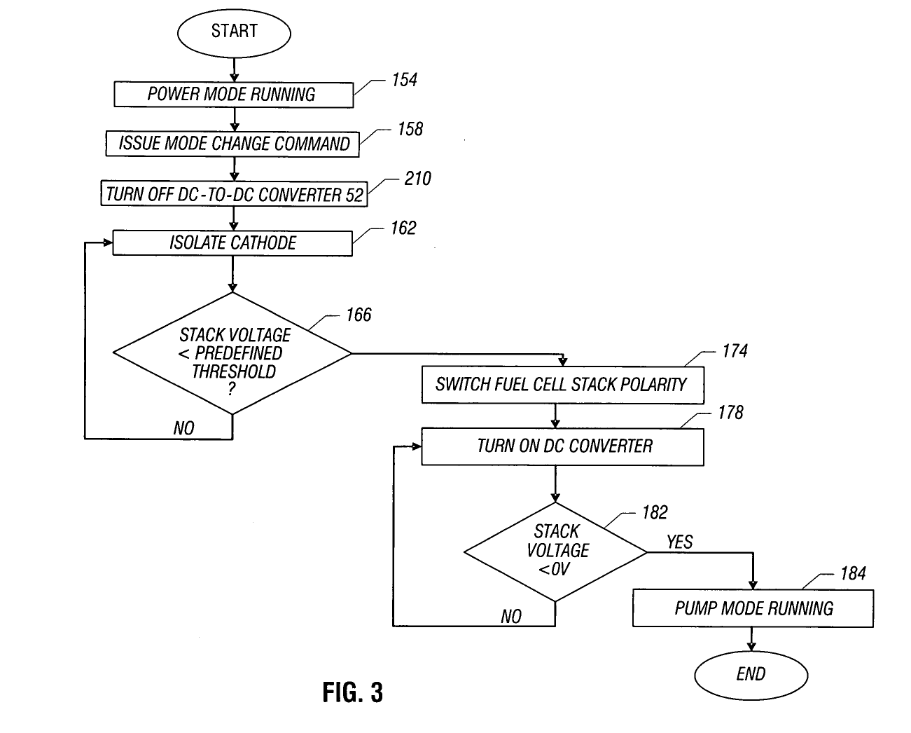

As a more specific example, in accordance with other embodiments of the invention, the electrochemical cell system 10 may perform a natural diffusion technique 200 that is depicted in FIG. 3. In general, the technique 200 is similar to the technique 150 (see FIG. 2), with similar reference numerals being used to depict similar acts. However, unlike the technique 150, the technique 200 includes turning off the DC-to-DC converter 52, pursuant to block 210, at the beginning of the transition (i.e., after the issuance of the mode change command, pursuant to block 158). Thus, the technique 200 removes the load from the stack 20 before the isolation of the cathode (pursuant to block 162). The stack voltage due to the natural diffusion of the hydrogen and inert gases from the anode chamber to the cathode chamber under the stack voltage is less than a predefined threshold, such as 2 volts (as a non-limiting example).

As examples of another variation, a power source that is separate from the power conditioning subsystem 50 may be activated to provide power to the stack 20 during the pumping mode. Thus, for these embodiments of the invention, the power conditioning subsystem 50 serves as a load only and is activated during the power producing mode.

Referring to FIG. 1, as another example of a variation, in accordance with some embodiments of the invention, a gas other than hydrogen and reformate may be communicated through the anode chamber of the stack 20 during the transitioning of the stack 20 from the power producing mode to the pumping mode. For example, using the above-described diffusion transition technique 200 (see FIG. 3), a hydrocarbon, such as natural gas, may be communicated through the anode chamber while the stack 20 is transitioning between the modes. More specifically, the valve 24 may be closed to isolate the fuel processor 26 from the anode inlet 22, and a valve 25 (normally closed) may be opened for purposes of communicating the incoming hydrocarbon flow to the fuel processor 26 to the anode inlet 22. The hydrocarbon and inert gases naturally diffuse from the anode chamber to the cathode chamber pursuant to the technique 200, and the end of the transitioning process is indicated when the stack voltage has decreased below a predefined threshold.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
operating an electrochemical cell stack in a power producing mode, comprising communicating a fuel flow in an anode chamber of the stack and communicating an oxidant flow in a cathode chamber of the stack;
halting the oxidant flow and monitoring a voltage of the stack while the oxidant flow is halted; and
in response to the voltage decreasing below a predefined threshold, transitioning the stack into an electrochemical cell pumping mode.

2. The method of claim 1, wherein the act of transitioning comprises:
turning off a voltage converter that receives a voltage from the stack and reconfiguring the voltage converter to provide a voltage to the stack during the electrochemical cell pumping mode.

3. The method of claim 2, further comprising:
turning on the voltage converter after the reconfiguration of the voltage converter.

4. The method of claim 2, further comprising:
determining whether the stack has transitioned into the electrochemical pumping mode based on a voltage of the stack.

5. The method of claim 1, further comprising:
disconnecting a load from the stack prior to the halting of the oxidant flow.

6. The method of claim 1, further comprising:
disconnecting a load from the stack after the voltage decreases below the predefined threshold.

7. The method of claim 1, further comprising:
continuing the communication of the fuel flow in the anode chamber during the halting of the oxidant flow and the monitoring of the voltage of the stack.

8. The method of claim 1, further comprising:
replacing the fuel flow in the anode chamber with a hydrocarbon flow in the anode chamber during the halting of the oxidant and the monitoring of the voltage of the stack.

9. A system comprising:
an oxidant source to provide an oxidant flow;
a fuel source to provide a fuel flow;
an electrochemical cell stack comprising an anode chamber and a cathode chamber; and
a control subsystem adapted to:
communicate the fuel flow in an anode chamber and communicate the oxidant flow in the cathode chamber in a power producing mode of the stack;
halt the oxidant flow and monitor a voltage of the stack while the oxidant flow is halted; and
in response to the voltage decreasing below a predefined threshold, transition the stack into an electrochemical cell pumping mode.

10. The system of claim 9, further comprising:
a voltage converter to receive a voltage generated by the stack when the stack is in the power producing mode, wherein
the control subsystem is adapted to turn off the voltage converter and subsequently reconfigure the voltage converter to provide a voltage to the stack during the electrochemical cell pumping mode.

11. The system of claim 9, wherein the control subsystem is adapted to turn on the voltage converter after the reconfiguration of the voltage converter.

12. The system of claim 9, wherein the control subsystem is adapted to determine whether the stack has transitioned into the electrochemical pumping mode based on a voltage of the stack.

13. The system of claim 9, wherein the control subsystem is adapted to disconnect a load from the stack prior to the halting of the oxidant flow.

14. The system of claim 9, wherein the control subsystem is adapted to disconnect a load from the stack after the voltage decreases below the predefined threshold.

15. The system of claim 9, wherein the control subsystem is adapted to continue the communication of the fuel flow in the anode chamber during the halting of the oxidant flow and the monitoring of the voltage of the stack.

16. The system of claim 9, wherein the control subsystem is adapted to halt the communication of the fuel flow in the anode chamber and communicate a hydrocarbon flow in the anode chamber during the halting of the oxidant flow and the monitoring of the voltage of the stack.
